(19) United States
(12) Patent Application Publication
(10) Pub. No.: US 2025/0245607 A1
(43) Pub. Date: Jul. 31, 2025

(54) INFORMATION PROCESSING DEVICE AND METHOD FOR PROVIDING MaaS

(71) Applicant: TOYOTA JIDOSHA KABUSHIKI KAISHA, Toyota-shi (JP)

(72) Inventors: Mayuko ABE, Tokyo (JP); Toshiki KASHIWAKURA, Tokyo (JP); Koki MORIYA, Nagakute-shi (JP); Yuta TAKATA, Toyota-shi (JP); Jean sebastien BOIRE, Yokohama-shi (JP); Takashi YASUDA, Tokyo (JP); Tsuyoshi OKADA, Nagoya-shi (JP)

(73) Assignee: TOYOTA JIDOSHA KABUSHIKI KAISHA, Toyota-shi (JP)

(21) Appl. No.: 18/918,087

(22) Filed: Oct. 17, 2024

(30) Foreign Application Priority Data
Jan. 29, 2024 (JP) 2024-011311

(51) Int. Cl. G06Q 10/0833

(52) U.S. Cl. CPC G06Q 10/0833

(57) ABSTRACT

An information processing device includes: a communication unit configured to communicate with a terminal device of a user; and a control unit configured to: acquire location data indicating a location of a delivery vehicle; calculate a distance from the location indicated by the acquired location data to a delivery destination; calculate from the calculated distance an estimated time that is an estimated amount of time until the delivery vehicle arrives at the delivery destination; and when the calculated estimated time becomes less than a threshold time, enable reception of a notification that the user is temporarily unavailable to receive delivery from the terminal device via the communication unit.

### CROSS-REFERENCE TO RELATED APPLICATION

This application claims priority to Japanese Patent Application No. 2024-011311 filed on Jan. 29, 2024, incorporated herein by reference in its entirety.

### BACKGROUND

### 1. Technical Field

The present disclosure relates to information processing devices and methods for providing Mobility as a Service (MaaS).

### 2. Description of Related Art

Japanese Unexamined Patent Application Publication No. 2002-321793 (JP 2022-321793 A) discloses a method in which, if a recipient of a package is absent when delivery is made, the package is stored in a package storage device near the recipient's address, and at the same time, the recipient is notified of the attempted delivery of the package.

### SUMMARY

In the conventional method, when there is a package that a user wants to receive in person but he or she is temporarily unavailable to receive the package, the user cannot notify a delivery vehicle of that situation.

The present disclosure allows a user to notify a delivery vehicle that he or she is temporarily unavailable to receive delivery.

An information processing device according to the present disclosure includes:
a communication unit configured to communicate with a terminal device of a user; and
a control unit configured to: acquire location data indicating a location of a delivery vehicle; calculate a distance from the location indicated by the acquired location data to a delivery destination; calculate from the calculated distance an estimated time that is an estimated amount of time until the delivery vehicle arrives at the delivery destination; and when the calculated estimated time becomes less than a threshold time, enable reception of a notification that the user is temporarily unavailable to receive delivery from the terminal device via the communication unit.

The present disclosure allows the user to notify the delivery vehicle that he or she is temporarily unavailable to receive delivery.

### BRIEF DESCRIPTION OF THE DRAWINGS

Features, advantages, and technical and industrial significance of exemplary embodiments of the disclosure will be described below with reference to the accompanying drawings, in which like signs denote like elements, and wherein:

FIG. 1 is a diagram illustrating a configuration of a system according to an embodiment of the present disclosure;

FIG. 2 is a block diagram illustrating a configuration of an information processing device according to an embodiment of the present disclosure;

FIG. 3 is a flowchart illustrating an operation of the information processing device according to the embodiment of the present disclosure;

FIG. 4 is a flowchart illustrating a first modification of the operation of the information processing device according to the embodiment of the present disclosure; and

FIG. 5 is a flowchart illustrating a second modification of the operation of the information processing device according to the embodiment of the present disclosure.

### DETAILED DESCRIPTION OF EMBODIMENTS

Hereinafter, an embodiment of the present disclosure will be described with reference to the drawings.

In each drawing, the same or corresponding portions are denoted by the same reference signs. In the description of the present embodiment, description of the same or corresponding components will be appropriately omitted or simplified.

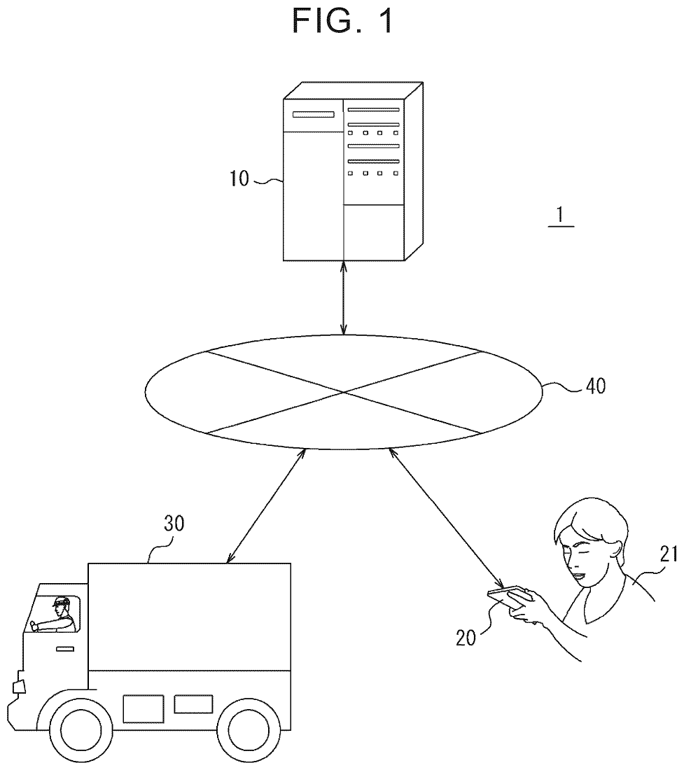

A configuration of the system 1 according to the present embodiment will be described with reference to FIG. 1.

The system 1 according to the present embodiment includes an information processing device 10, a terminal device 20, and a delivery vehicle 30. The information processing device 10 is capable of communicating with the terminal device 20 and the delivery vehicle 30 via the network 40.

The information processing device 10 is installed in a facility such as a data center and is operated by a business operator who manages the delivery vehicle 30. The information processing device 10 is a computer such as a server belonging to a cloud computing system or another computing system.

The terminal device 20 is a computer capable of installing and executing an application program such as a PC, a mobile phone, a smart phone, or a tablet. The term “PC” is an abbreviation for “personal computer”. The terminal device 20 is used by the user 21.

Delivery vehicle 30 is any type of vehicle, such as a gasoline vehicle, diesel vehicle, hydrogen vehicle, HEV, PHEV, BEV, or FCEV, for example. The term “HEV” is an abbreviation for “hybrid electric vehicle”. The term “PHEV” is an abbreviation for “plug-in hybrid electric vehicle”. The term “BEV” is an abbreviation for “battery electric vehicle”. The term “FCEV” is an abbreviation for “fuel cell electric vehicle”. In the present embodiment, the delivery vehicle 30 is a large vehicle such as a truck. The delivery vehicle 30 is driven by a driver in the present embodiment, but the driving may be automated at an arbitrary level. The level of autonomous driving is, for example, one of levels 1 to 5 in the SAE leveling, for example. The term “SAE” is an abbreviation for the “Society of Automotive Engineers”. The delivery vehicle 30 may be a MaaS dedicated vehicle. The term “MaaS” is an abbreviation for “mobility as a service”.

The network 40 includes the Internet, at least one WAN, at least one MAN, or any combination thereof. The term “WAN” is an abbreviation for “wide area network”. The term “MAN” is an abbreviation for “metropolitan area network”. The network 40 may include at least one wireless network, at least one optical network, or any combination thereof. The wireless network is, for example, an ad hoc network, a cellular network, a wireless LAN, a satellite communication network, or a terrestrial microwave network. The term “LAN” is an abbreviation for “local area network”.

The outline of the present embodiment will be described with reference to FIG. 1.

The information processing device 10 acquires location data indicating the location of the delivery vehicle 30. The information processing device 10 calculates the distance from the location indicated by the acquired location data to the delivery destination. The information processing device 10 calculates an estimated time, which is an estimated amount of time until the delivery vehicle 30 arrives at the delivery destination, based on the calculated distance. When the calculated estimated time becomes less than the threshold time, the information processing device 10 enables reception of a notification that the user is temporarily unavailable to receive delivery from the terminal device 20 via the communication unit.

According to the present embodiment, it is possible to notify the delivery vehicle 30 that the user 21 is temporarily unavailable to receive delivery.

In FIG. 1, a user 21 is a purchaser who orders a product on an EC website and requests delivery. “EC” is an abbreviation for E-Commerce. The delivery vehicle 30 delivers a package, which is a product ordered by the user 21, to a delivery destination designated by the user 21. In the present embodiment, the delivery destination is the home of the user 21. The user 21 wishes to receive the package directly. The delivery destination is not limited to the home of the user 21, but includes any place where the user 21 can directly receive the package, such as a hotel or a work place.

The delivery vehicle 30 is driven by a driver who refers to the delivery data to deliver the baggage. The delivery data indicates the order in which the delivery vehicle 30 delivers the package. The delivery data is stored in the information processing device 10 in the form of a database. When the delivery data is acquired from the information processing device 10, the delivery vehicle 30 presents the delivery data to the driver. The delivery vehicle 30 delivers the package to the first delivery destination in the order indicated by the delivery data. When the delivery is completed, the delivery data is updated, and the second delivery destination in order becomes the head.

In one embodiment, the information processing device 10 may be used to provide MaaS that is a service that utilizes mobility.

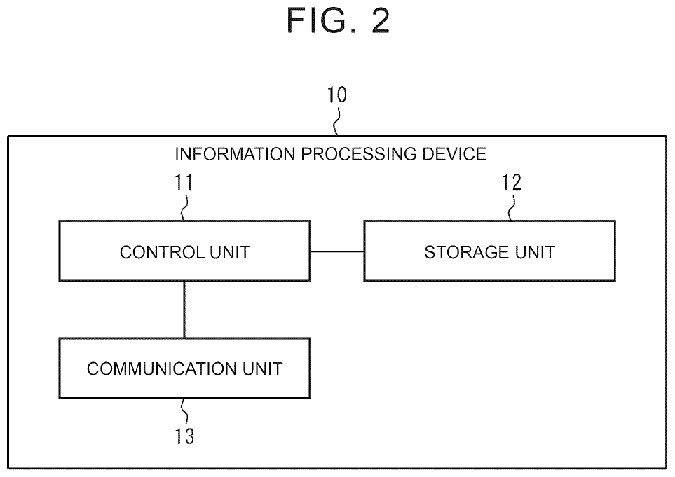

A configuration of the information processing device 10 according to the present embodiment will be described with reference to FIG. 2.

The information processing device 10 includes a control unit 11, a storage unit 12, and a communication unit 13.

The control unit 11 includes at least one processor, at least one programmable circuit, at least one dedicated circuit, or any combination thereof. The processor is a general-purpose processor such as a CPU or a GPU, or a dedicated processor specialized for a specific process. The term “CPU” is an abbreviation for “central processing unit”. The term “GPU” is an abbreviation for “graphics processing unit”. The programmable circuit is, for example, an FPGA. The term “FPGA” is an abbreviation for “field-programmable gate array”. The dedicated circuit is, for example, an ASIC. The term “ASIC” is an abbreviation for “application specific integrated circuit”. The control unit 11 executes processing related to the operation of the information processing device 10 while controlling each unit of the information processing device 10.

The storage unit 12 includes at least one semiconductor memory, at least one magnetic memory, at least one optical memory, or any combination thereof. The semiconductor memory is, for example, a RAM, a ROM, or a flash memory. The term “RAM” is an abbreviation for “random access memory”. The term “ROM” is an abbreviation for “read-only memory”. The RAM is, for example, an SRAM or a DRAM. The term “SRAM” is an abbreviation for “static random access memory”. The term “DRAM” is an abbreviation for “dynamic random access memory”. The ROM is, for example, an EEPROM. The term “EEPROM” is an abbreviation for “electrically erasable programmable read only memory”. The flash memory is, for example, an SSD. The term “SSD” is an abbreviation 20 for solid-state drive. The magnetic memory is, for example, an HDD. The term “HDD” is an abbreviation for hard disk drive. The storage unit 12 may function as, for example, a main storage device, an auxiliary storage device, or a cache memory. The storage unit 12 stores data used for the operation of the information processing device 10 and data acquired through the operation of the information processing device 10. In the present embodiment, at least delivery data is stored in the storage unit 12.

The communication unit 13 includes at least one communication module. The communication module is, for example, a module compliant with a wired LAN communication standard such as Ethernet (registered trademark), a wireless LAN communication standard such as IEEE802.11, or a mobile communication standard such as LTE, 4G standard or 5G standard. The term “IEEE” is an abbreviation for Institute of Electrical and Electronics Engineers. The term “LTE” is an abbreviation for “long term evolution”. The term “4G” is an abbreviation for “fourth generation”. The term “5G” is an abbreviation for “fifth generation”. The communication unit 13 communicates with the delivery vehicle 30 via the network 40. The communication unit 13 receives data used for the operation of the information processing device 10 and sends data obtained by the operation of the information processing device 10.

The function of the information processing device 10 is realized by executing the program according to the present embodiment by a processor as the control unit 11. That is, the functions of the information processing device 10 are realized by software. The program causes the computer to execute the operation of the information processing device 10, thereby causing the computer to function as the information processing device 10. That is, the computer functions as the information processing device 10 by executing the operation of the information processing device 10 in accordance with the program.

The program can be stored in a non-transitory computer-readable medium. The non-transitory computer-readable medium is, for example, a flash memory, a magnetic recording device, an optical disc, a magneto-optical recording medium, or a ROM. The distribution of the program is carried out, for example, by selling, transferring, or renting a portable medium such as an SD card, a DVD, or a CD-ROM in which the program is stored. The term “SD” is an abbreviation for “secure digital”. The term “DVD” is an abbreviation for “digital versatile disc”. The term “CD-ROM” is an abbreviation for “compact disc read only memory”. The program may be stored in the storage of the server and transferred from the server to other computers to distribute the program. The program may be provided as a program product.

The computer temporarily stores the program stored in the portable medium or the program transferred from the server in the main storage device, for example. The computer then causes the processor to read the program stored in the main storage device, and causes the processor to execute processes in accordance with the read program. The computer may read the program directly from the portable medium and execute processes in accordance with the program. The computer may execute the processes in accordance with the received program each time the program is transferred from the server to the computer. The processes may be executed by a so-called ASP service that realizes the function only by execution instruction and result acquisition without transferring the program from the server to the computer. The term “ASP” is an abbreviation for “application service provider”. The program includes information that is used for processing by electronic computers and equivalent to a program. For example, data that is not a direct command to a computer but has the property of defining the process of the computer corresponds to the “data equivalent to a program”.

Some or all of the functions of the information processing device 10 may be realized by a programmable circuit or a dedicated circuit as the control unit 11. That is, some or all of the functions of the information processing device 10 may be realized by hardware.

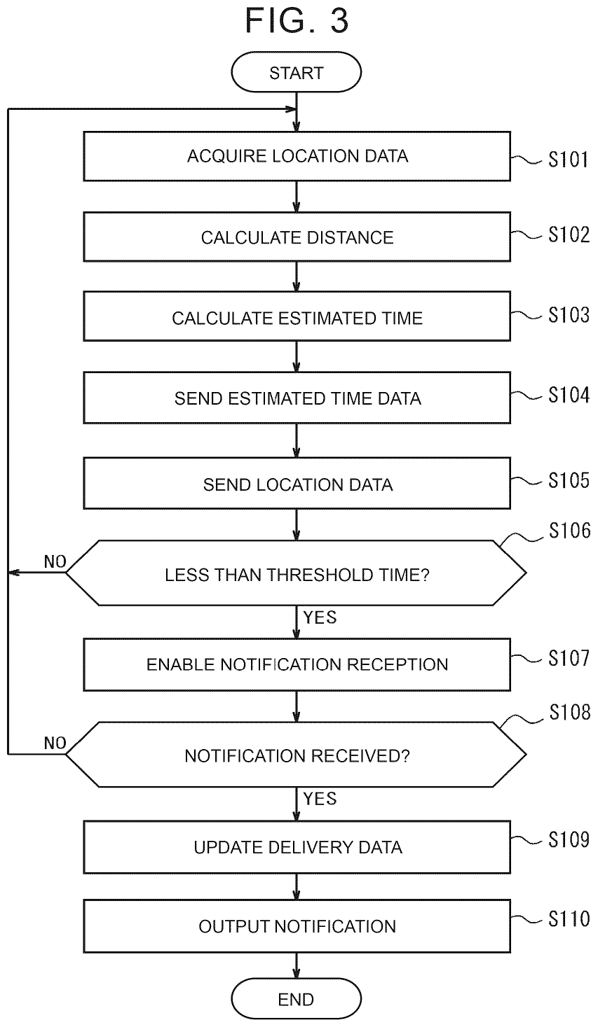

An operation of the information processing device 10 according to the present embodiment will be described with reference to FIG. 3. The operation described below corresponds to the method according to the present embodiment. That is, the methods according to the present embodiment include the steps of S110 from S101 shown in FIG. 3.

In the present embodiment, when the delivery vehicles 30 depart from the nearest branch of the delivery destination, S101 is started.

In S101, the control unit 11 of the information processing device 10 acquires location data indicating the location of the delivery vehicles 30. Specifically, the delivery vehicle 30 measures the location of the delivery vehicle 30 by GPS receiver mounted on the delivery vehicle 30. The term “GPS” is an abbreviation for “global positioning system”. The delivery vehicle 30 sends data indicating the measured location to the information processing device 10 as location data. The control unit 11 receives the sent location data via the communication unit 13.

In S102, the control unit 11 of the information processing device 10 calculates the distance from the location indicated by the location data acquired by S101 to the delivery destination. For example, the control unit 11 calculates the distance from the location indicated by the location data to the home of the user 21.

In S103, the control unit 11 of the information processing device 10 calculates an estimated time, which is an estimated amount of time until the delivery vehicles 30 arrives at the delivery destination, based on the distance calculated by S102. For example, the control unit 11 calculates an estimated time until the delivery vehicle 30 arrives at the home of the user 21 by considering the distance calculated by S102 and the order in which packages are delivered, the road condition, the weather, or the time of the day.

In S104, the control unit 11 of the information processing device 10 sends the estimated time data indicating the estimated time calculated by S103 to the terminal device 20 via the communication unit 13. The terminal device 20 receives the sent estimated time data. The terminal device 20 displays the estimated time indicated by the received estimated time data on the display. For example, when the estimated time is 15 minutes, the terminal device 20 displays a message “the package will arrive in the next 15 minutes” on the screen of the display. Alternatively, the terminal device 20 may display, on the screen, a message of loosening, such as “if the package arrives in about 15 minutes or Nyan”, with an illustration of a cat.

In S105, the control unit 11 of the information processing device 10 sends the location data acquired by S101 to the terminal device 20 via the communication unit 13. The terminal device 20 receives the sent location data. The terminal device 20 displays the location indicated by the received location data on the display. For example, the terminal device 20 displays a map around the location of the delivery vehicle 30 on the screen of the display, and displays an icon of the track at the location of the delivery vehicle 30 on the map.

In S106, the control unit 11 of the information processing device 10 determines whether the estimated time calculated by S103 is less than the threshold time. If it is less than the threshold time, the control unit 11 performs S107 process. If it is equal to or longer than the threshold time, the control unit 11 performs S101 process. The threshold time is, for example, 15 minutes. When the estimated time is less than 15 minutes, the control unit 11 performs S107 process. When the estimated time is 15 minutes or more, the control unit 11 performs S101 process. S101 process is performed after the predetermined period has elapsed after the determination of S106. The predetermined time may vary depending on the estimated time. For example, when the estimated time is 60 minutes or more, the control unit 11 performs S101 process 30 minutes after the determination of S106. When the estimated time is less than 60 minutes and 30 minutes or more, the control unit 11 performs S101 process after 10 minutes elapse after the determination of S106. When the estimated time is less than 30 minutes and 15 minutes or more, the control unit 11 performs S101 process after 5 minutes elapse after the determination of S106. When the estimated time is less than 15 minutes, the control unit 11 performs S107 process.

In S107, the control unit 11 of the information processing device 10 enables reception of a notification that the user is temporarily unavailable to receive delivery from the terminal device 20 via the communication unit 13. Specifically, the control unit 11 notifies the terminal device 20 that reception of a notification that the user is temporarily unavailable to receive delivery has been enabled. The terminal device 20 displays on the display that the information processing device 10 has enabled notification reception. For example, the terminal device 20 displays a message such as “Press the button when unavailable” or “Press the button to request front door delivery” on the screen of the display. Further, the terminal device 20 displays buttons such as “unavailable for five minutes”, “unavailable for 10 minutes”, or “prefer front door delivery” on the screen. The user 21 presses a button when he or she is temporarily unavailable to receive delivery for a short period of time.

In S108, the control unit 11 of the information processing device 10 determines whether or not a notification from the terminal device 20 has been received. Specifically, when the user 21 presses a button, the terminal device 20 sends a notification indicating that the button has been pressed to the information processing device 10. The control unit 11 receives a notification via the communication unit 13. Upon receiving the notification, the control unit 11 performs a S109 process. When a predetermined period of time has elapsed without reception of any notification since notification reception was enabled in S107, the control unit 11 performs the process of S101. The predetermined time is, for example, 5 minutes. The control unit 11 performs the process of S101 when five minutes have elapsed since notification reception was enabled in S107.

In S109, the control unit 11 of the information processing device 10 updates the delivery data stored in the storage unit 12. The method of updating the delivery data may vary depending on the content of the notification received by S108. For example, when the notification indicating that the button “unavailable for five minutes” has been pressed is received, the control unit 11 reverses the order of the delivery destination of the user 21 and the second delivery destination. When the notification indicating that the button “unavailable for 10 minutes” has been pressed is received, the control unit 11 moves back the delivery destination of the user 21 by three positions in order. When receiving a notification indicating that the button “prefer front door delivery” is pressed, the control unit 11 changes the delivery method of the user 21 to “front door delivery”.

In S110, the control unit 11 of the information processing device 10 outputs a notification. Specifically, the control unit 11 sends update data indicating the content updated by S109 to the delivery vehicles 30 via the communication unit 13. The delivery vehicle 30 receives the update data. The delivery vehicle 30 outputs the content indicated by the update data as a notification. For example, when the delivery destination of the user 21 is changed, the delivery vehicle 30 displays a message “The delivery destination is changed” and the changed delivery destination on the screen of the display of the navigation system mounted on the delivery vehicle 30. If the delivery method of the user 21 is changed, the delivery vehicle 30 displays a message “changed to front door delivery” on the display screen of the navigation system. The delivery vehicle 30 may output these messages from speakers built in the delivery vehicle 30. In accordance with such notification, the delivery vehicle 30 is driven by the driver so as to correspond to the changed delivery destination or delivery method.

After S110, the process illustrated in FIG. 3 ends. Further, when the delivery to the user 21 is completed, the flow illustrated in FIG. 3 ends, regardless of which processing is performed in FIG. 3.

In an exemplary embodiment, the above-described process may be executed when providing MaaS using the delivery vehicles 30. In this case, the information processing method according to the above-described process is an exemplary method of providing MaaS using the delivery vehicles 30.

As described above, in the present embodiment, the control unit 11 of the information processing device 10 acquires location data indicating the location of the delivery vehicle 30. The control unit 11 of the information processing device 10 calculates the distance from the location indicated by the acquired location data to the delivery destination. The control unit 11 of the information processing device 10 calculates an estimated time, which is an estimated amount of time until the delivery vehicle 30 arrives at the delivery destination, based on the calculated distance. When the calculated estimated time becomes less than the threshold time, the control unit 11 of the information processing device 10 enables reception of a notification that the user is temporarily unavailable to receive delivery from the terminal device 20 via the communication unit 13.

According to the present embodiment, it is possible to notify the delivery vehicle 30 that the user 21 is temporarily unavailable to receive delivery.

As a modification of the present embodiment, the control unit 11 of the information processing device 10 may notify the terminal device 20 of the fact that the second estimated time calculated again by S103 is different from the time obtained by simply subtracting the elapsed time from the previously calculated estimated time. The second estimated time is the estimated time calculated again by S103 when the flow returns to S101 after the calculation of the estimated time by S103. Specifically, the second estimated time calculated again by S103 may be different from the estimated time indicated by the estimated time data sent by S104 minus the elapsed time. In this case, the control unit 11 sends, to the terminal device 20 via the communication unit 13, a notification indicating that the estimated time has changed, together with the second estimated time data indicating the second estimated time. The terminal device 20 receives the second estimated time data and the notification. The terminal device 20 displays the second estimated time and the notification indicated by the received second estimated time data on the display. For example, the estimated time calculated by S103 is 10 minutes, and the estimated time data is sent to the terminal device 20 by S104, and thereafter, five minutes have elapsed without receiving the notification from the terminal device 20 by S108. In this situation, the control unit 11 returns to S101 and calculates the second estimated time in S103. The estimated time indicated by the estimated time data sent in S104 minus elapsed time is 10 minutes−5 minutes=5 minutes. When the second estimated time is calculated to be 15 minutes due to the congestion of the road on which the delivery vehicle 30 travels, the control unit 11 sends, to the terminal device 20, a notification indicating that the estimated time has changed together with the second estimated time data indicating 15 minutes, which is the second estimated time. The terminal device 20 displays a message “The estimated time has been extended by 10 minutes” on the screen of the display.

As another modification of the present embodiment, S104 may be omitted. In this situation, the control unit 11 calculates the estimated time in S103, and then sends the location data in S105 without sending the estimated time data. The terminal device 20 receives the location data. The terminal device 20 displays the location indicated by the received location data on the display.

As yet another modification of the present embodiment, S105 may be omitted. In this situation, the control unit 11 calculates the estimated time by S103, then sends the estimated time data by S104, and does not send the location data. The terminal device 20 receives the estimated time data. The terminal device 20 displays the estimated time indicated by the received estimated time data on the display.

As yet another modification of the present embodiment, S104 and S105 may be omitted. After calculating the estimated time by S103, the control unit 11 does not send the estimated time data and the location data, and determines whether the estimated time is less than the threshold time by S106.

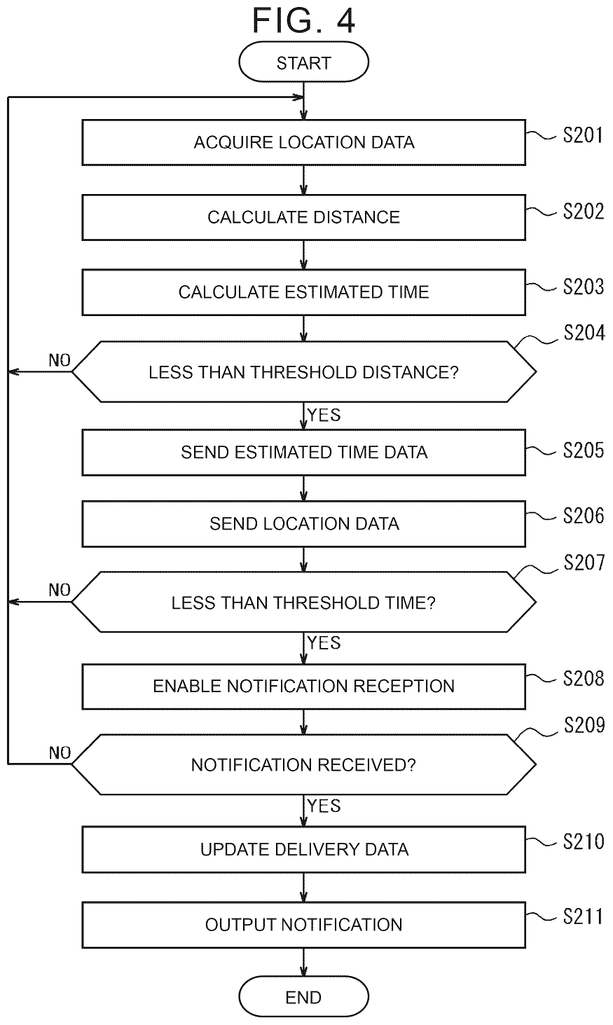

A first modification of the operation of the information processing device 10 according to the present embodiment will be described with reference to FIG. 4. However, the steps from S201 to S203 and S205 to S211 are the same as the steps from S101 to S103 and S104 to S110 shown in FIG. 3, and therefore will not be described.

In S204, the control unit 11 of the information processing device 10 determines whether or not the distance calculated by S202 is less than the threshold distance. If it is less than the threshold distance, the control unit 11 performs a S205 process. When the distance is equal to or larger than the threshold distance, the control unit 11 performs a S201 process. That is, when the distance calculated by S202 becomes less than the threshold distance, the control unit 11 sends the estimated time data in S205. The threshold distance is, for example, 2 km. When the distance is less than 2 km, the control unit 11 performs S205 process. When the distance is equal to or larger than 2 km, the control unit 11 performs S201 process. S201 process is performed after the predetermined period has elapsed after the determination of S204. The predetermined time may vary with distance. For example, when the distance is greater than or equal to 5 km, the control unit 11 performs S201 process 30 minutes after the determination of S204. When the distance is less than 5 km and equal to or greater than 3 km, the control unit 11 performs S201 process after 10 minutes elapse after the determination of S204. When the distance is equal to or larger than 3 km value 2 km, the control unit 11 performs S201 process 5 minutes after the determination of S204. When the distance is less than 2 km, the control unit 11 performs S205 process. The predetermined time may vary depending on the estimated time calculated by S203. The variation of the predetermined time with the estimated time is similar to S106.

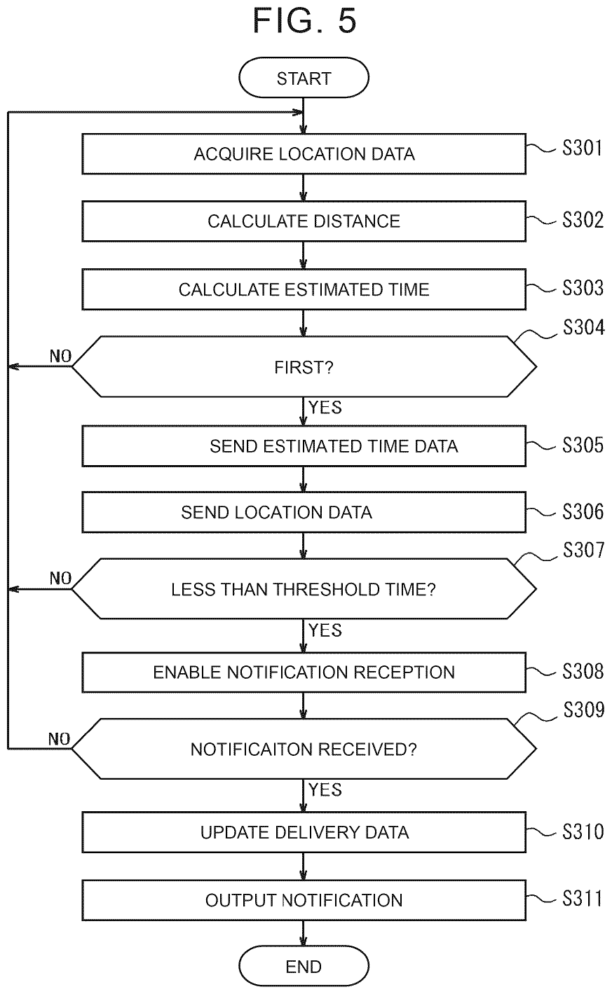

A second modification of the operation of the information processing device 10 according to the present embodiment will be described with reference to FIG. 5. However, the steps from S301 to S303 and S305 to S311 are the same as the steps from S101 to S103 and S104 to S110 shown in FIG. 3, and therefore will not be described.

In S304, the control unit 11 of the information processing device 10 refers to the delivery data and determines whether the delivery destination of the user 21 is first in the order. When the delivery destination is first in the order, the control unit 11 performs a S305 process. When the delivery destination is not first in the order, the control unit 11 performs S301 process. Thus, the estimated time is notified only to the user of the delivery destination to be delivered next.

The present disclosure is not limited to the embodiment described above. For example, two or more blocks shown in the block diagram may be integrated, or a single block may be divided. Instead of executing two or more steps shown in the flowchart in chronological order according to the description, the steps may be executed in parallel or in a different order, depending on the processing capacities of the devices that execute the steps, or as necessary. Other changes may be made without departing from the scope of the present disclosure.

For example, the information processing device 10 may be mounted on the delivery vehicle 30. That is, the operations illustrated in FIGS. 3 to 5 may be performed by the delivery vehicle 30.

What is claimed is:

1. An information processing device, comprising:
a communication unit configured to communicate with a terminal device of a user; and
a control unit configured to:
acquire location data indicating a location of a delivery vehicle;
calculate a distance from the location indicated by the acquired location data to a delivery destination;
calculate from the calculated distance an estimated time that is an estimated amount of time until the delivery vehicle arrives at the delivery destination; and
when a calculated estimated time becomes less than a threshold time, enable reception of a notification that the user is temporarily unavailable to receive delivery from the terminal device via the communication unit.

2. The information processing device according to claim 1, wherein the control unit is configured to send estimated time data indicating the estimated time to the terminal device via the communication unit.

3. The information processing device according to claim 2, wherein the control unit is configured to also send the location data to the terminal device via the communication unit.

4. The information processing device according to claim 2, wherein the control unit is configured to send the estimated time data when the distance becomes less than a threshold distance.

5. The information processing device according to claim 2, wherein the control unit is configured to refer to delivery data indicating an order in which the delivery vehicle delivers packages, and send the estimated time data when the delivery destination becomes first in the order.

6. A method for providing mobility-as-a-service using the information processing device according to claim 1.
